(19) United States
(12) Patent Application Publication
(10) Pub. No.: US 2007/0095643 A1
(43) Pub. Date: May 3, 2007

(54) Operating device with a touch switch

(75) Inventors: Josef Weiss, 78586 Deiningen (DE); Ewald Bayer, 72858 Dormettingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. ELEKTRO-GERAETEBAU GMBH, Oberderdingen (DE)

(21) Appl. No.: 11/549,380

(22) Filed: Oct. 13, 2006

Related U.S. Application Data
(63) Continuation of application No. PCT/EP05/03943, filed on Apr. 14, 2005.

(30) Foreign Application Priority Data
Apr. 15, 2004 (DE) 10 2004 019 304.5

(51) Int. Cl. H01H 1/02

(52) U.S. Cl. 200/511

(57) ABSTRACT

A touch-sensitive switch is disclosed whose electrical circuit is provided on a printed board (28). The touch-sensitive switch is coupled to a touch-sensitive switching area (12) on a panel or cover (11) of an electrical appliance via a sensor element (44). The sensor element (44) consists of a flexible, electrically conducting plastic or foam material. Two parts (24, 25) of the sensor element (44) are received in a receiving element or receiving cage (18) which is produced from an electrically insulating, transparent plastic. Said receiving element or cage electrically insulates the two sensor element parts (24, 25) from each other by means of a dividing wall (21) and encases them from the exterior, thereby providing a sufficiently long air and leakage path between current-carrying elements and an opening (16) in the panel. A lighting element projects through said path and guides the light emitted by an LED (29) to a light outlet in the switching area (12) in the manner of a light guide. Alternatively, an interior casing (23) can be provided downstream of the opening (16) and sealingly surrounds the lighting element (15), across the air and leakage path, and at the same time retains the sensor element (44).

### CROSS REFERENCE TO RELATED APPLICATIONS

This application claims priority from PCT Application No. PCT/EP2005/003943, filed Apr. 14, 2005, which is based on German Application Number 10 2004 019 304.5, which was filed Apr. 15, 2005, of which the contents of both are hereby incorporated by reference.

### FIELD OF APPLICATION

The invention generally relates to an operating device for operating an electrical appliance having a proximity or touch switch according.

### BACKGROUND

Touch switches are known from EP 859 467 A1. In the case of such switches, the contact surface whose touching or approach is evaluated for the switching process by electronic circuitry, is determined by a sensor element located beneath a cover or surface and which is made from an electrically conductive, flexible material, e.g. a rubbery plastic or foam. This leads to a good contacting of the underside of the cover and ensures constant conditions. For signalling the switching which has taken place, a light emitting diode is used and is placed in the center of a circular ring-shaped sensor element on the printed circuit board carrying the sensor element and trans-illuminates through the transparent or translucent surface, e.g., a glass ceramic plate.

The problem of the invention is to design such an operating device in such a way that it ensures maximum safety for the operator with the most varied types of covers and even under extreme environmental conditions.

### BRIEF DESCRIPTION OF THE DRAWINGS

Embodiments of the invention are described in greater detail hereinafter relative to the attached diagrammatic drawings, wherein show:

FIG. 1 A diagrammatic plan view of the cover or panel of an electrical appliance.

FIG. 2 A longitudinal section through part of an operating device.

FIG. 3 A section along line III-III in FIG. 2.

FIG. 4 A plan view of an operating device with a touch switch.

FIG. 5 A partial cross-section through the cover and touch switch of FIG. 4.

FIG. 6 A plan view corresponding to FIG. 4 with an opening positioned eccentrically to the switching area.

FIG. 7 A section through a detail of the touch switch.

FIG. 8 A view along arrow VIII in FIG. 7, without circuit board.

### DETAILED DESCRIPTION

In one embodiment of the present invention, e.g. in the case of a non-transparent cover, such as a laundry dryer panel made from coloured plastic, a light emitting element for signalling the switching process (e.g., as when the user turns “on” the appliance) projects in the pushbutton area direction through an opening in the cover. Even if the light emitting element is ideally fitted, small gaps can arise and e.g. water can pass through the opening between the light emitting element and the cover (e.g., the gap), creating what can be termed an “air and leakage path”. The air and leakage path between a contactable part and a live part (e.g., electrically charged), according to some regulations, must be normally be 12 mm or more. The electrically insulating envelope of the sensor or light emitting element on the periphery thereof creates said leakage path without impairing the action of the electrically conductive sensor element.

In one embodiment, the sensor element is constructed in two parts. One part can rest on the corresponding circuit board contact and the other part contacts the cover. Between the two is electrical insulation, so that the part adjacent to the cover is galvanically isolated from the live part engaging on the circuit board. However, it has been found that the effectiveness and control coupling of the sensor element to the circuit of the touch switch is not impaired. The two-part nature makes it particularly easy to give the two end faces of the sensor element different sizes, so that a smaller end face takes up little space on the printed circuit board, whereas the larger end face of the part engaging on the cover ensures a comfortable size for a user to press on a switching area.

User operation is facilitated if the light emitting element is integrated into the touch contact surface and projects through the sensor element and, in particular, close to the cover. Thus, the switching area on the contact face surrounds the light emitting element. In one embodiment, the light emitting element is arranged eccentrically to the switching area, because then the operator does not automatically cover the same during the switching process, and can see the light emitting element during operation.

The sensor element, preferably the portion near the cover (“cover-contacting end”), can be constructed as a seal for the opening. This is particularly effective if said sensor element part has on its cover-contacting end face a closed surface, e.g., being constructed as a flexible, but still solid, rubbery plastic or as a foam with a closed-pore (waterproof) surface.

All these embodiments can be implemented using a reception element, which has a preferably cup-shaped receptacle belonging to the envelope for the support-near part of the sensor element. The reception element's bottom forms the insulation and carries on the other side a roughly shell or dish-shaped receptacle for the cover-near part of the sensor element, which can be constructed in relatively flat manner similar to a disk. The receptacle can be circular cylindrical, but the shell-shaped receptacle for the cover-near part has a larger diameter than the receptacle facing the printed circuit board. This leads to an offset outer face of the reception element, so that the necessary air and leakage path can be respected, without the spacing between the support (circuit board) and cover having to be too large.

The reception element can be produced as a transparent plastic injection moulding and therefore forms a light guide, where a projection projecting through the shell-shaped receptacle and which extends the casing of the cup-shaped receptacle forms a through light conducting path between a light generator placed on the circuit board, e.g. a light emitting diode (LED) and the light exit face of the light emitting element projecting through the opening.

The step formed as a result of the different diameters between the two receptacles can be enlarged by a rib e.g. surrounding half the circumference of the reception element and which in addition to its effect of increasing the air and leakage path also forms a dripping projection for any moisture which may have penetrated to collect on (in the worst possible case) so that the moisture does not reach the circuit board.

Thus, one embodiment of a touch switch is created, whose electric circuit is located on a printed circuit board. It is coupled by means of a sensor element to the touch switching area on an electrical appliance cover or panel. The sensor element can be made in two parts from a flexible, electrically conducting plastic or foam material. The two parts of the sensor element are received in a reception element of an electrically insulating, transparent plastic, which by means of a partition electrically insulates from one another the two sensor element parts and externally envelops the same, so that between the live parts adjacent to the circuit board and an opening in the panel with an adequate air and leakage path a light emitting element which, through a reception element also serving as a light guide, is illuminated by a LED on the circuit board.

The light emitting element can alternatively be surrounded by an envelope of the sensor element and can be directly connected to the opening so as to form the air and leakage path. Preferably, the sensor element surrounds the tubular envelope and is “engaged” thereon. In the case of an opening positioned eccentrically to the switching face, the envelope can touch or support the outer circumference of the sensor element and consequently also contribute to the bearing or mounting of said sensor element.

These and further features of preferred developments of the invention can be gathered from the claims, description and drawings and the individual features, both singly or in the form of subcombinations, can be implemented in an embodiment of the invention and in other fields and can represent advantageous, independently protectable constructions for which protection is claimed here.

FIG. 1 shows a front view of a cover 11 forming the panel of the operating part of a laundry dryer. On the same panel other input devices are defined e.g. as a start/stop button the switching area 12 of a proximity or touch switch 50 and is indicated by a marking 13, e.g. by corresponding printing or plastic highlighting. The cover is made from an opaque, i.e., non-transparent plastic or some other non-transparent material.

In the switching area it is possible to see the light exit face 14 of a light emitting element 15, which although being located within the switching area 12, is eccentric thereto and in the present case is upwardly displaced.

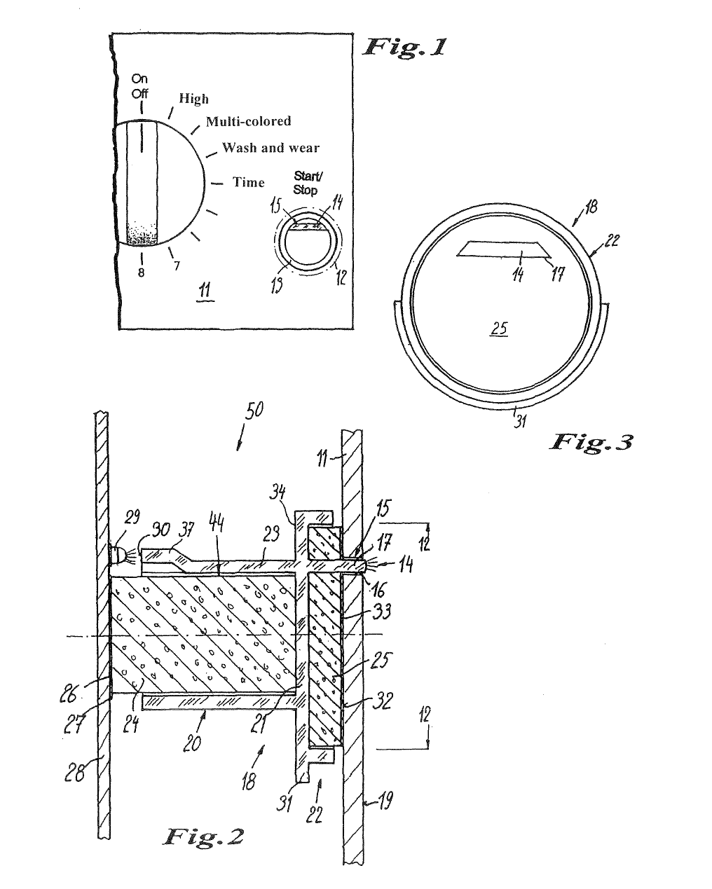

FIG. 2 shows in longitudinal section the cover 11, which at the location of the light emitting element 15 has an opening 16 in which engages the light emitting element in the form of an (in this embodiment) trapezoidal projection 17 of a reception element 18, so that the light exit face 14 is essentially terminated in a plane with the outer face 19 of the cover 11.

Reception element 18 is made from electrically non-conductive material, usually transparent injection moulded plastic, and contains two circular cylindrical portions with different diameters and whereof one portion forms a roughly cup-shaped receptacle 20. The bottom 21 or face of the receptacle simultaneously forms the face or bottom of an oppositely directed receptacle 22, which has a larger diameter than receptacle 20 and is significantly flatter or shallower, and may be shell or dish-shaped. The face or bottom 21 separating the two receptacles is extended in projecting manner over half the circumference (cf. FIG. 3), so that it forms a semi-cylindrical rib 31. Projection 17 traverses the shell-shaped receptacle 22 and is located in the extension of the wall of receptacle 20. The wall of receptacle 20 forms an envelope 23 for one part 24 of a sensor element 44, whose other part 25 is located in receptacle 22.

These sensor element parts 24, 25 are made from an electrically conductive, flexible plastic, plastic foam or rubber, as described in EP 859 467 A1 and which can also be referred to as conductive rubber. Express reference and incorporation is made with regards to the disclosure and also the function of the touch switch to EP 859 467 A1.

End face 26 projecting from receptacle 20 engages on a contact face 27, which is provided on a printed circuit board forming a support 28. In conventional manner the circuit board carries a printed circuit, which also includes the contact face 27 and contains the active and passive components, together with the conducting tracks of the touch switch, optionally also several touch switches and other control and regulating units for the electrical appliance. On said circuit board is also located a light emitting diode (LED) 29. As shown in FIG. 2, the LED is positioned adjacent to the outer receptacle wall 23 forming the envelope so that light is emitted into the end face 30. The receptacle wall is shown at this point having an outward bulge 37 in order to accommodate spacing between the diode and the sensor element.

The sensor element part 24 facing the circuit board and located in receptacle 20 is in the form of a relatively elongated cylinder (e.g., having a length greater than its diameter) and projects somewhat beyond the end face, i.e., out of receptacle 20. It can be made from a more flexible, electrically conductive material, e.g. foam.

The sensor element part 25 located in receptacle 22 is in the form of a somewhat thicker circular disk (e.g., having a diameter greater than its thickness) and is made from a material which is either semi-solid, but flexible, or from a foam, which on the end face 32 engaging on cover 11 is closed, e.g. by a skin 33, such as is e.g. the case with integral foams. Sensor element part 25 also projects somewhat over the outer wall of receptacle 22 and therefore provides a flexibility reserve. Projection 17 projects through a correspondingly shaped opening in sensor element part 25. Projection 17 is therefore surrounded by portions of said sensor element part 25, so that the light exit face 14 of the projection is within the switching area 12, which is essentially determined by the sensor element part 25.

Function

Reception element 18 is equipped with sensor element parts 24, 25 and introduced between support 28 and cover 11 in that the projection 17 is fitted into opening 16. This leads to a positive, mechanical fixing of the sensor element unit on the cover. It is also possible for equipping purposes for the sensor element or elements to be connected to the circuit board 28 of cover 11 and/or reception element 18 by an optionally electrically conductive contact adhesive.

With respect to the positioning, it is also pointed out that due to the two-part nature of the sensor element unit so as to give a smaller diameter, longer part 24 and a larger diameter, shorter part 25, in the case of a large switching area the contact face 26, 27 required on the circuit board can be smaller. It is also possible to achieve the independence from the precise spacing resulting from the elasticity of the sensor elements if there is an adequate contact pressure between cover 11 and support 28, without hindering the precise orientation of the light exit face 14 with the outer face 19 of the cover. Therefore sensor element part 25 can be made from a material with reduced elasticity, the main deformation taking place in the vicinity of the longer sensor element part 44. Most of the elasticity reserve is also stored there and ensures a uniform, full engagement of the sensor elements on the cover, support and bottom 21.

The side-wall envelope 23 of receptacles 20, 22 and the step 34 formed between the same and which is made from an electrically non-conducting material, acts as an external electrical insulation of sensor element 44 and the two sensor element parts 24, 25, which are galvanically isolated from one another. Correspondingly, an air and leakage path of at least 12 mm is formed between the circuit board or the face of the sensor element 44 projecting from receptacle 20 and the opening 16, or the portion of the sensor element part 44 projecting out of receptacle 22, without the spacing between the circuit board and cover having to be larger. The two sensor element parts 44 are at different electrical potentials. The electrical sensor part 24 contacts the circuit board, on which there can be an electronic resonant circuit, which can have live voltage, but the other electrical sensor part 25 is not electrically connected, and is in fact insulated therefrom by the divider 21. This arrangement does not adversely impact the function of the touch switch, because with capacitive touch switches, said sensor elements are parts of a capacitor and are already electrically insulated by the cover from the operating finger of the user.

The cross-section of the sensor elements, described here as being circular, can in particular have a various different designs or shapes, which can be adapted to the pushbutton shape. The same applies with regards to the light emitting element, which is shown with a trapezoidal cross-section.

Therefore the reception element has a multiple functions. It is, on the one hand, used for the mechanical and electrical separation of two sensor elements, but simultaneously provides the cohesion thereof, as well as their electrical insulation and providing an air and leakage path. It also serves as a light guide for the light emitting element and as a seal for opening 16 for preventing moisture penetrating the interior. It also permits functional separation between the two sensor element parts and the use of different materials for the same to ensure the positioning of the light emitting element on or in panel 11.

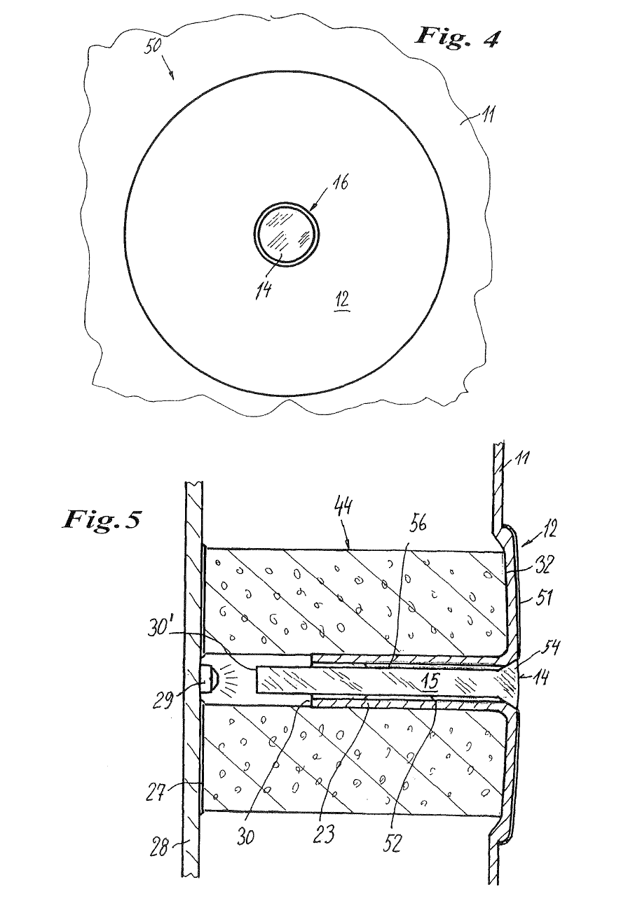

FIGS. 4 and 5 show a touch switch 50 having a circular switching area 12 and which is bounded by a cover 11. FIG. 5 shows that the switching area 12 is shaped into the cover 11 as an optionally slightly spherical elevation thereof. It can additionally be provided with an e.g. metallic covering or coating 51, which sets it off from the surroundings.

An opening 16 is shaped into the cover in the centre of switching area 12 and continues in an inner channel 52 formed within a tubular envelope 23, shaped internally on cover 11, i.e., is integrally connected thereto.

A light emitting element 15 is engaged in the tubular reception channel. It is made from a pellucid plastic and is constructed in pin-like manner with a smaller diameter than the reception channel 52, so that it is surrounded by an air gap 56. Inner ribs (not shown) centre the light emitting element 15. The light emitting element has a head 54 similar to that of a nail, whose head face forms the light exit face 14. Head 54 is located in a countersink of the opening and beneath it can be optionally placed a seal (not shown). The light emitting element is fixed by clamping or snapping-in using, for example, latching elements or by bonding adhesives (not shown). The envelope 23 is uninterrupted up to its lower end face 30 and is as long as the desired or necessary so as to accommodate an air and leakage paths as desired, i.e., more than 12 millimeters.

The tubular sensor element 44 is engaged on the tubular envelope 23 and its upper end face 32 engages in the switching area, i.e., on the underside of cover 11, which is lowered somewhat there in accordance with the external elevation of the switching area. The tubular envelope carries and guides the sensor element which is well retained thereon due to its elasticity. It projects over and beyond the envelope 23 and is located, as described by means of FIG. 2, on the annular contact face 27 of printed circuit board 28. In the centre of said contact face is provided the light emitting diode 29, which consequently faces the light entry face 30′ of the light emitting element. The latter acts as a light guide for the exit of light from the light exit face 14.

It is clear that here a particularly simple and effective possibility is created for providing a light exit face with light guide inserted in an opening of a cover, which on the one hand can be tightly inserted and provides the desired air and leakage path as necessary between the first touch contact possibility by an operator (outside of the switching area) and the electrically conductive sensor element 44, i.e. the area close to end face 30.

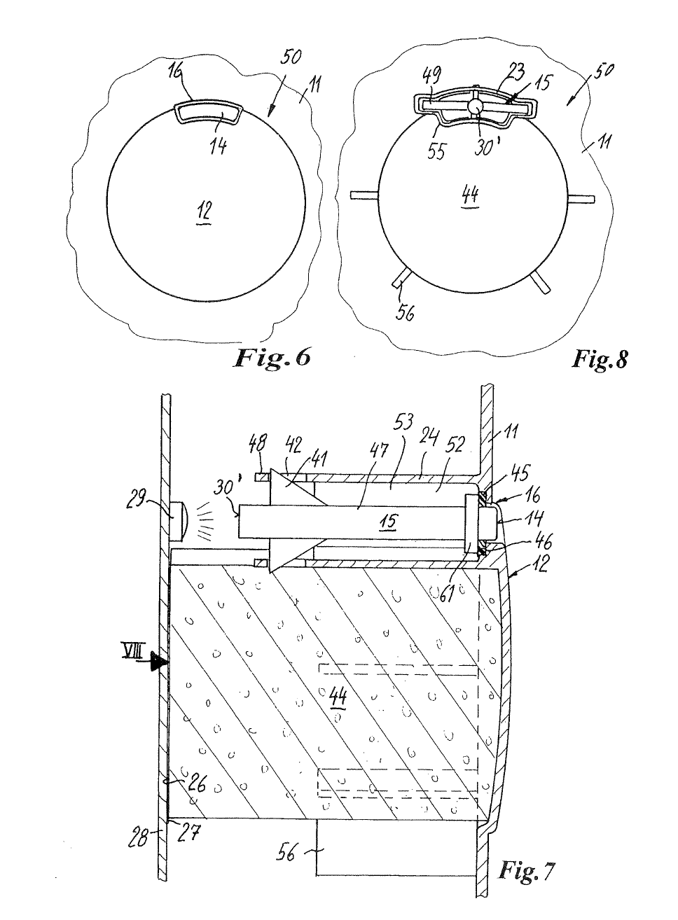

FIGS. 6 to 8 show another embodiment in which the switching area 12 shaped into cover 11 is once again circular, but contains an opening 16, which is formed within the circular surface, but on the edge thereof in the form of a circular segment. Correspondingly the light exit face 14 of the light emitting element 15 located therein is circular segmental.

FIG. 7 shows that the opening 16 is formed in a recess of the somewhat elevated switching face 12 of cover 11. Through said opening 16 projects the light guide constructed in the form of a flat or bent pin. The exit face 14 projects through the opening, but not over and beyond the switching face 12 and is instead level with the cover 11. To said projection is connected a collar 61, which supports a seal 45, which is located in an inner depression 46 of the cover and seals the opening with inserted light guide. To the collar is connected a longer shaft 47 of the light guide, which carries lateral latching elements 41 in the form of sawtooth-like projections, which cooperate with corresponding cutouts forming latching elements 42 on envelope 24 or tongues 48 extending the latter in the manner of a snap hinge closure. The shaft, which is circular in this area, projects beyond the latching elements 41 and ends in end face 30′, which is the light entry face for the light from light emitting diode 29 above which it is positioned.

FIG. 8 shows the flat, bent shape of the pellucid light emitting element 15 with lateral guidance ribs 49. Envelope 24 is adapted to the shape of light emitting element 15, reference being made to FIG. 8 concerning its precise shape. It is shaped onto the cover 1 1, but could also be tightly connected thereto and surrounds the light emitting element 15 with a relatively large air gap 53. It is uninterrupted up to the openings forming the latching elements 42, where the tongues 48 commence. The latter are constructed in such a way that on insertion of the light emitting element (from left to right in the drawing) they spring apart somewhat and consequently form the snap hinge closure.

The flexible, electrically conducting sensor element 44 is basically shaped like a circular cylinder, but at one point is constructed with a circular segmental recess 55, which matches the external shape of the envelope in this area. Thus, the sensor element 44 is directly connected to said envelope, which also forms part of its fastening holders. The remaining holders are formed by ribs 56 shaped onto cover 11. Thus, the sensor element can be inserted from the left between said holders and as a result of the elasticity sinks somewhat into the surface and consequently keeps the sensor element pressed onto the underside of switching area 12. The other end face 26 of sensor element 44 is located on contact face 27.

Here again envelope 42 shields the light emitting element 15 or inner channel 52 therein against dropping below the air and leakage path from live parts to the contactable surface. This construction simultaneously serves a function in conjunction with the holding and securing of the sensor element.

1. An operating device for operating an electrical appliance comprising a sensor element of a touch or proximity switch, the sensor element being made from flexible, electrically conductive material having a first and second face, wherein a first face positioned on a cover as the touch contact face and forming there a switching area, the second face of the sensor element being placed on a support in the form of a printed circuit board provided with electrical conductors and with a light emitting element within the switching area, the operating device characterized by the light emitting element project through an opening of the cover, by an electrically insulating envelope creating an air-resistant and leakage-resistant path.

2. The operating device according to claim 1, characterized in that the light emitting element guiding the light is illuminated by a light emitting diode mounted on the printed circuit board.

3. The operating device according to claim 2, characterized in that the sensor element (44) is constructed in two parts with the first part having the first face of the sensor element contacting the cover and the second part of the sensor element having the second face contacting a conductor on the support (28), wherein an electrical insulator is provided between the first part and the second part.

4. The operating device according to claim 2, characterized in that the light emitting element projects through the first part of the sensor element wherein the first part of the sensor element contacts both the switching area of the cover and the light emitting element.

5. The operating device according to claim 4, characterized in that the first part of the sensor element is constructed as a seal for an opening in which the light emitting element projects through the cover.

6. The operating device according claim 3, characterized by a reception element (18) having a cylindrical shaped receptacle forming a first cavity for receiving at least a portion of the first part of the sensor element, the reception element having a second cylindrical shaped receptacle forming a second cavity for receiving at least a portion of the second part of the sensor element, the reception element having the electrical insulator between the first part and second part, wherein the first cavity has a diameter larger than said second cavity.

7. The operating device according to claim 6, characterized in that the reception element (18) comprises the emitting element having a first and second end, a light emitting diode positioned to illuminate the first end and exiting at the second end, the second end forming a projection passing through an opening in the cover in the switching area.

8. The operating device according to claim 7, characterized in that the distance between the first end of the light emitting element and the opening in the cover is at least 12 millimeters.

9. The operating device according to claim 7, characterized by a projection on the reception element, located in the bottom portion for forming a dripping projection.

10. The operating device according to claim 3 characterized in that the first part of the sensor element is of a cylindrical shape having a first diameter and the second part of the sensor element is of a cylindrical shape having a second diameter, wherein the first diameter is larger than the second diameter.

11. The operating device according to claim 7 characterized in that the projection has a cross sectional shape that is the same shape as the opening in the cover in the switching area.

12. The operating device according to claim 1, characterized in that the envelope forms a tubular part, which is surrounded by the sensor element, the tubular part in turn surrounding a portion of the the light emitting element, the light emitting element comprising a head forming a face which is not surrounded by the tubular part.

13. The operating device according to claim 6, characterized in that the envelope is located adjacent to the sensor element and forms an outer retaining face for the sensor element located on part of the outer face of said sensor element.

14. The operating device according to claim 13, characterized in that the light emitting element has a projection cooperating with a latching element on the envelope.

15. The operating device according to claim 13 characterized in that the opening and the light emitting element are circular in cross section and located off-center in the switching area, the envelope engaging in a marginal cutout of sensor element.

16. The operating device according to claim 2, characterized in that an air gap is formed between light emitting element and envelope.
